(19) United States
(12) Patent Application Publication
(10) Pub. No.: US 2023/0061938 A1
(43) Pub. Date: Mar. 2, 2023

(54) ACCESSORY CASE

(71) Applicant: TECHTRONIC CORDLESS GP, Anderson, SC (US)

(72) Inventors: Thomas Evatt, Six Mile, SC (US); Jeremy Fedrigon, Greenville, SC (US); Trevor C. Fauss, Greenville, SC (US); Sajan Arvindkumar Mistry, Greenville, SC (US); Peter J. Roberts, Greenville, SC (US); Allison M. Chesser, Greenville, SC (US); Christopher L. Heintz, Greenville, SC (US)

(21) Appl. No.: 17/822,973

(22) Filed: Aug. 29, 2022

Related U.S. Application Data
(60) Provisional application No. 63/238,499, filed on Aug. 30, 2021.

(51) Int. Cl. B25H 3/00; B65D 25/20; B67B 7/16; A45F 5/02; G01B 3/04

(52) U.S. Cl. CPC B25H 3/003; A45F 5/021; B65D 25/20; B67B 7/16; G01B 3/04

(57) ABSTRACT

A case includes a first housing portion, a second housing portion, a first auxiliary structure, and a second auxiliary structure. The second housing portion is movably coupled to the first housing portion and cooperates with the first housing portion to define a storage space. The first auxiliary structure is disposed on one of the first housing portion and the second housing portion. The second auxiliary structure is disposed on one of the first housing portion and the second housing portion. The first auxiliary structure is a foot disposed on and extending from an exterior surface of the first housing portion. The foot is configured to abut a workpiece to orient the workpiece in at least one preset angle relative to the first housing portion. The second auxiliary structure is a recess.

### CROSS-REFERENCE TO RELATED APPLICATION

This application claims the benefit of co-pending U.S. Provisional Pat. Application No. 63/238,499, filed Aug. 30, 2021, the entire content of which is incorporated herein by reference.

### TECHNICAL FIELD

The present disclosure relates to storage systems, and more particularly to containers for tool accessories and the like.

### BACKGROUND

Hand tools, power tools, and associated accessories such as batteries, tool bits, sockets, accessories, fasteners, and the like, may be moved frequently between a storage space and a work space.

### SUMMARY

In one independent aspect, a case includes a first housing portion, a second housing portion, a first auxiliary structure, and a second auxiliary structure. The second housing portion is movably coupled to the first housing portion and cooperates with the first housing portion to define a storage space. The first auxiliary structure is disposed on one of the first housing portion and the second housing portion. The second auxiliary structure is disposed on one of the first housing portion and the second housing portion. The first auxiliary structure is a foot disposed on and extending from an exterior surface of the first housing portion. The foot is configured to abut a workpiece to orient the workpiece in at least one preset angle relative to the first housing portion. The second auxiliary structure is a recess.

In another independent aspect, a system including a first case and a second case. The first case includes a first housing portion and a second housing portion coupled to the first housing portion and cooperating with the first housing portion to define a first storage space. The first case further includes a first hinge coupling the first housing portion to the second housing portion to define the storage space between the first housing portion and the second housing portion. The first case further includes a first auxiliary structure disposed on and extending from a first exterior surface of the first case. The first auxiliary structure is configured to abut a workpiece to orient the workpiece in at least one preset angle relative to the first case. The second case includes a third housing portion and a fourth housing portion coupled to the third housing portion and cooperating with the third housing portion to define a second storage space. The second case further includes a second hinge coupling the third housing portion to the fourth housing portion to define the second storage space between the third housing portion and the fourth housing portion. The second case further includes a second auxiliary structure disposed on a second exterior surface of the second case, wherein the second auxiliary structure is a recess. The first auxiliary structure is configured to align with a portion of the second auxiliary structure to facilitate stacking of the first case over the second case.

Other aspects of the disclosure will become apparent by consideration of the detailed description and accompanying drawings.

### BRIEF DESCRIPTION OF THE DRAWINGS

FIG. 1 is a front perspective view of a case including a front housing and a rear housing.

FIG. 2 is a rear perspective view of the case of FIG. 1.

FIG. 3 is a front view of the case of FIG. 1.

FIG. 4 is a rear view of the case of FIG. 1.

FIG. 5 is a side view of the case of FIG. 1.

FIG. 6 is an opposite side view of the case of FIG. 1.

FIG. 7 is a top view of the case of FIG. 1.

FIG. 8 is a bottom view of the case of FIG. 1.

FIG. 9 is a front view of the rear housing of FIG. 1.

FIG. 10 is a rear view of the front housing of FIG. 1.

FIG. 11 is a rear view of another case configured to position a workpiece between feet of the case at various positions relative to the case.

FIG. 12 is a drill bit reference guide which may be applied to the case of FIG. 1.

FIG. 13 is a screw pitch measuring device which may be applied to the case of FIG. 1.

FIG. 14 is a front view of a belt clip which may be applied to the case of FIG. 1.

FIG. 15 is a perspective view of the belt clip of FIG. 14.

FIG. 16 is a perspective view of the case of FIG. 1 supported by a kick stand.

FIG. 17 is a perspective view of a bit bar for use with the case of FIG. 1.

FIG. 18 is another perspective view of the bit bar of FIG. 17.

FIG. 19 is another front view of the case of FIG. 1 with the case angled relative to a work piece.

FIG. 20 is another side view of the case of FIG. 1 with the side of either the front housing or the rear housing provided with indicia.

FIG. 21 is a perspective view of a system including two cases of FIG. 1 stacked on one another.

### DETAILED DESCRIPTION

Before any aspects are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

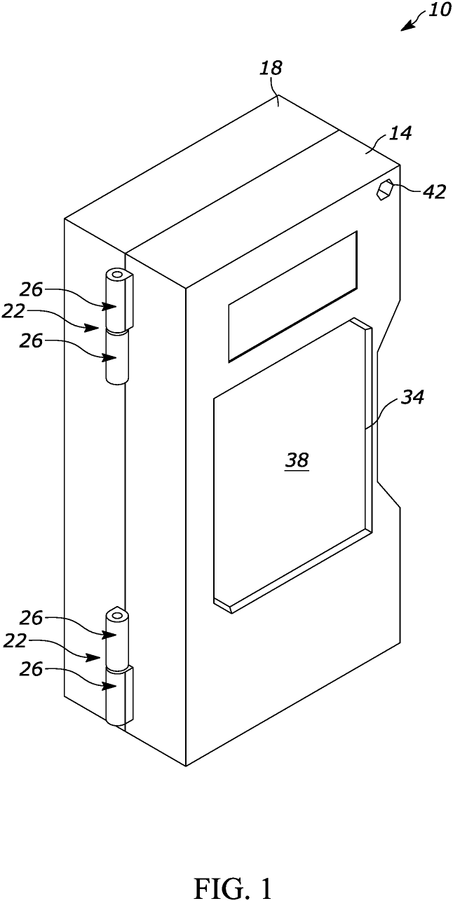

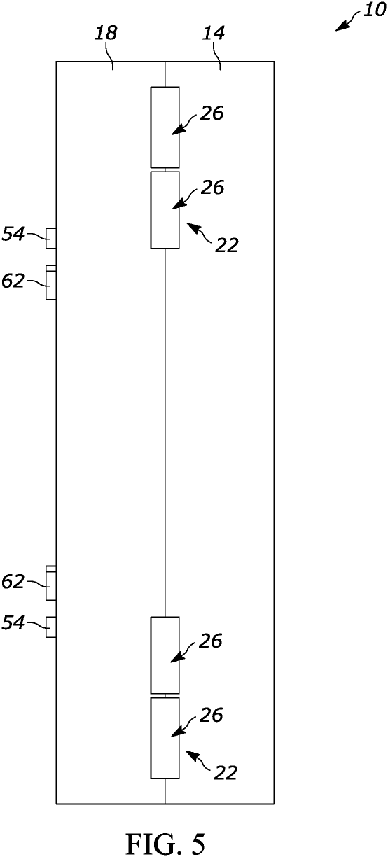

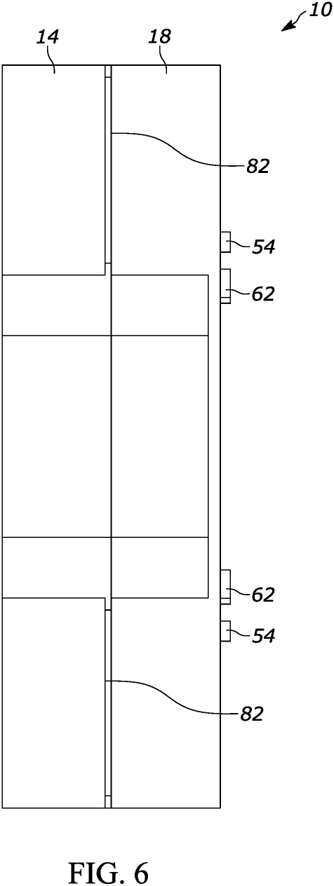

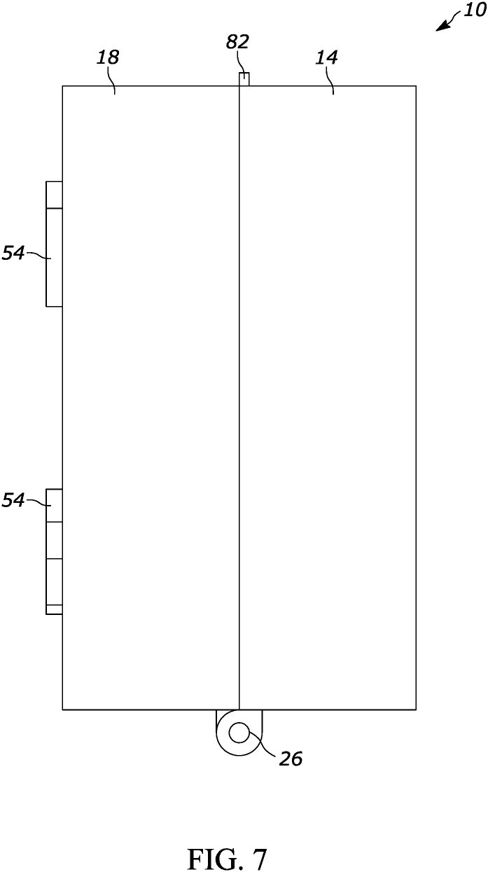

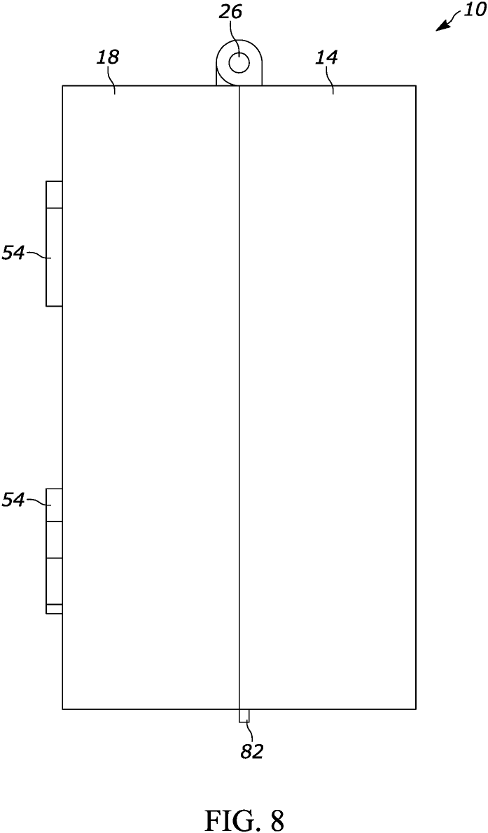

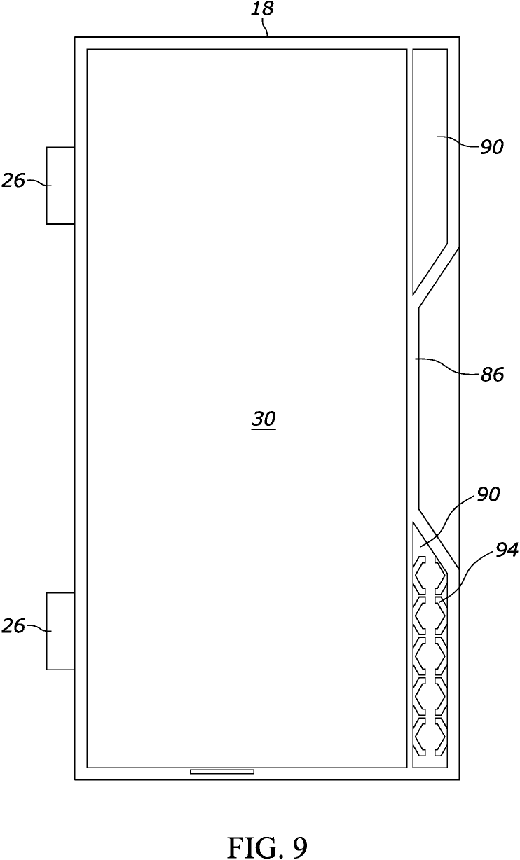

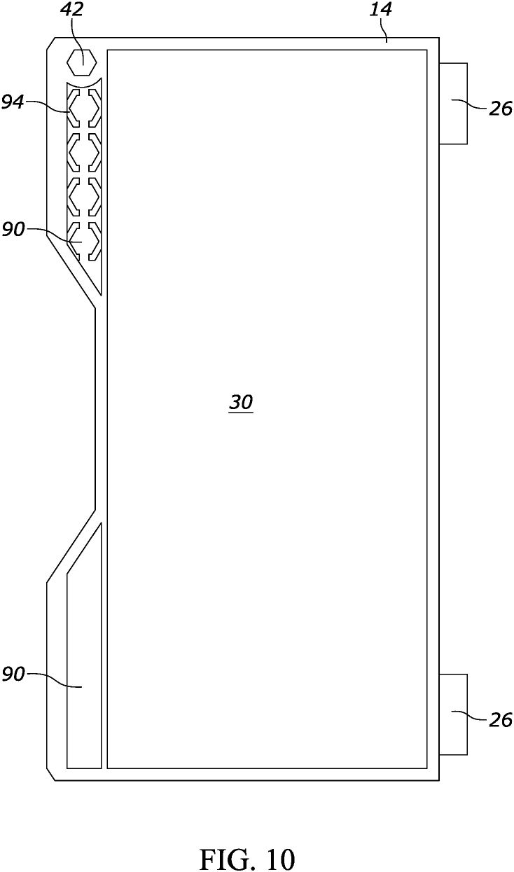

FIGS. 1-11 illustrate an accessory case 10. The case 10 includes a front housing 14 (i.e., also referred to as a first housing) and a rear housing 18 (i.e., also referred to as a second housing) coupled to each other by a hinge 22. The hinge 22 includes hinge portions 26 disposed on the front housing 14 and the rear housing 18 that interact with each other to movably couple the front housing 14 and the rear housing 18 together. FIGS. 1-8 illustrate the case 10 in a closed position. However, the front housing 14 and the rear housing 18 may be pivoted, rotated, and/or translated relative to each other to expose a storage space 30 (FIGS. 9, 10) within the case 10 (i.e., an internal storage space 30) and defined between the front housing 14 and the rear housing 18. The storage space 30 may be used to house bits (e.g., drill bits, cutting bits, and/or the like), accessories (e.g., pencils, blades, hex keys, and/or the like), or any other type of items therein.

The case 10 may be provided with at least one structure on an exterior or interior of either the front housing 14 or the rear housing 18. In some embodiments, multiple structures are disposed on the front housing 14, the rear housing 18, or a combination of the respective front and rear housings 14 and 18. The structure is configured to permit the case 10 to provide and/or facilitate a secondary, auxiliary function, purpose, and/or task, that is separate from providing mere storage. That is, the case 10 may primarily provide storage by way of a storage structure (e.g., the front housing 14 and the rear housing 18), and additionally provide at least one other secondary (e.g., auxiliary) aspect (e.g., measurement, stability, alignment with workpiece) by way of measuring structures, holding (e.g., stabilizing) structures, alignment structures, and/or the like.

As shown in FIG. 1, the structure includes a recessed tray 34. The recessed tray 34 may be provided on an exterior surface of the front housing 14, although providing a recessed tray 34 on an interior surface of the front (or rear) housing is also contemplated. The recessed tray 34 is configured to define a storage space 38 on the exterior of the case 10 (i.e., a second or exterior storage space 38). The exterior storage space 38 may receive fasteners, bits, or other accessories therein, and inhibit the fasteners, bits, or other accessories from sliding beyond the bounds of the recessed tray 34. In some embodiments, the case 10 is further provided with a magnet (not shown) within the recessed tray 34 to further secure metallic fasteners, bits, or other accessories to the case 10. For example, one or more surfaces forming the recessed tray 34 may be magnetic, receive a magnet, and/or include magnets. In this way, the recessed tray 34 may be considered an auxiliary (e.g., secondary) structure which performs an auxiliary function (e.g., defining the exterior storage space 38 for storing an object on the exterior of the case 10) other than and/or in addition to defining a storage space between the front housing 14 and the rear housing 18.

With continued reference to FIG. 1, the feature may include a hex insert 42. The illustrated hex insert 42 is an external hex insert 42 provided on the exterior of the front housing 14. The illustrated external hex insert 42 is configured to receive a hexagonal fastener, bit, or other accessory therein. A user may quickly store the hexagonal fastener, bit, or other accessory within the hex insert 42 when not needed, and the hex insert 42 will retain the fastener, bit, or other accessory when needed without requiring the user to open the case 10. The hex insert 42 may be molded in a portion of the front housing 14. In other embodiments, the hex insert 42 may be a through hole extending through both the front housing 14 and the rear housing 18. Accordingly, the hex insert 42 may be considered an auxiliary structure which performs an auxiliary function (e.g., providing, on the exterior of the front housing 14, a space to receive a hexagonal fastener) other than defining a storage space between the front housing 14 and the rear housing 18. As persons having skill in the art will understand, the case 10 may include primary structures (e.g., the front housing 14 and the rear housing 18) that provide an internal storage space 30 in addition to one or more secondary (e.g., auxiliary) structures (e.g., tray 34, hex insert 42, etc.) that provide secondary functions in addition to storage. Case 10 may include any combination of multiple, different types of secondary structures.

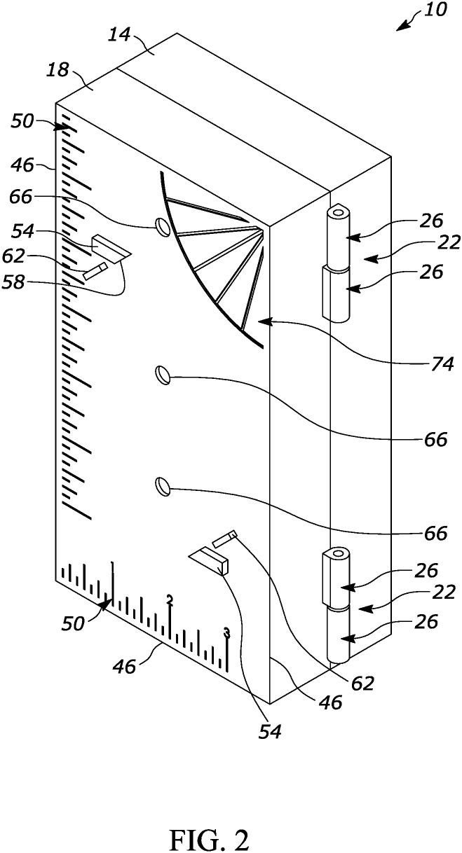

As shown in FIG. 2, the structure may include a straight edge 46 or a ruler 50. The front housing 14 and/or the rear housing 18 may include straight edges 46 which may be used to scribe a straight line in, on, and/or over a workpiece (e.g., wood, tile, drywall, and/or the like). In the illustrated embodiment, the rear housing 18 includes a ruler 50 corresponding to both the vertical and horizontal directions defined by the rear housing 18. The ruler 50 may include indicia corresponding to lengths along the straight edges 46. Accordingly, the straight edge 46 and ruler 50 may each be considered an auxiliary structure which performs an auxiliary function (e.g., providing a straight edge for drawing and/or measuring lines) other than defining a storage space between the front housing 14 and the rear housing 18.

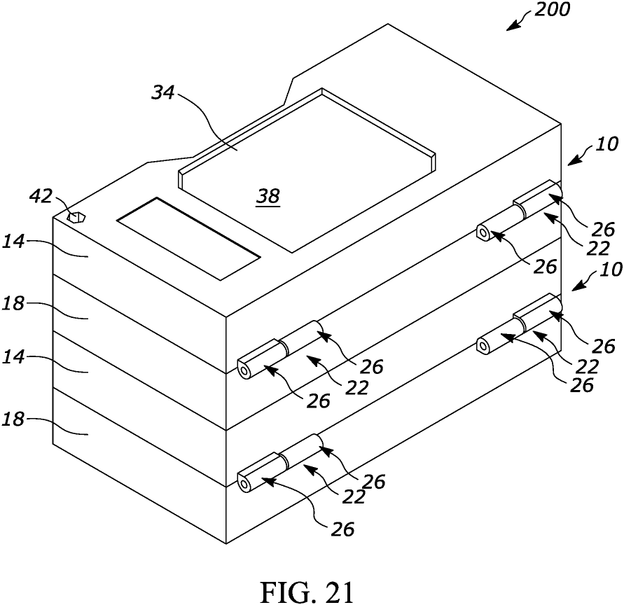

As shown in FIG. 2, the structure may include one or more projections or feet 54 extending beyond the rear housing 18 and away from the front housing 14. Each foot 54 may include an angled surface 58. Each foot 54 may be located on the rear housing 18 at a position aligned with and corresponding to an outer perimeter of the recessed tray 34 (i.e., on the front housing 14) and the exterior storage space 38. With reference to FIG. 21, a system 200 includes the case 10 attached to or mounted on another case 10, the foot 54 and the angled surface 58 of one case 10 (e.g., a first case) may be received within the exterior storage space 38 of another case 10 (e.g., a second case) so that adjacent cases 10 may be stacked on top of each other. In some embodiments, the rear housing 18 may include one or more angled projections 62 that may be separate and distinct from the foot 54 (and separate and distinct from any other feet 54) and may generally align with the angled surface 58. Accordingly, the foot 54 may be considered an auxiliary structure which performs an auxiliary function (e.g., at least stacking adjacent cases 10 on top of each other as shown in FIG. 21) other than defining a storage space between the front housing 14 and the rear housing 18.

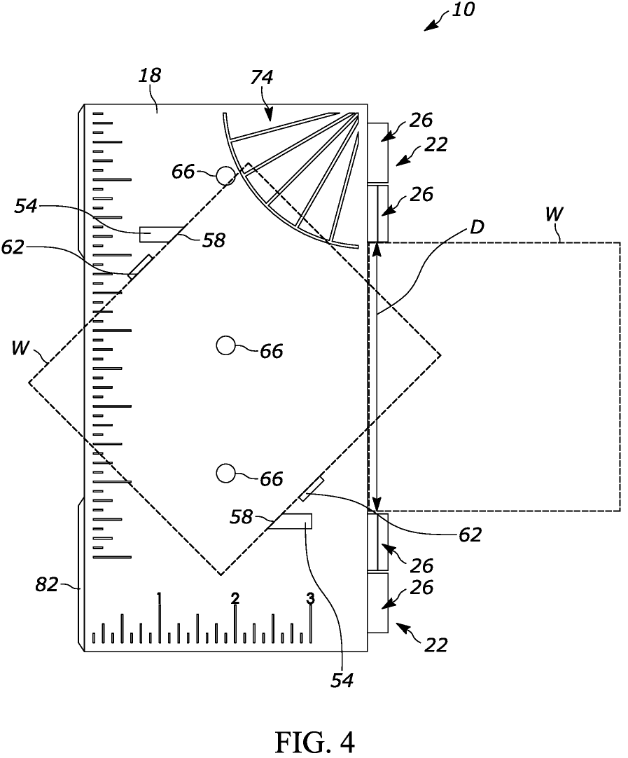

With reference to FIG. 4, a workpiece W may be brought into contact with either one or both of the feet 54 of the rear housing 18 depending on the orientation of the workpiece W relative to the rear housing 18. When the workpiece W is in contact with either foot 54 or both feet 54, the workpiece W may also contact one or more angled projections 62. In the illustrated embodiment, the angled surface 58 of the feet 54 and the angled projections 62 are dimensioned to locate the workpiece at a 45-degree angle relative to the straight edge 46. In other embodiments, the angled surface 58 and the angled projections 62 may be otherwise dimensioned to locate the workpiece W at other common angles (e.g., 15, 22.5, 30, 45, 60, 75 degrees, and/or the like) relative to the straight edge 46. The workpiece W may be seated between opposing feet 54 such that workpiece W is angled at about a 45-degree angle relative to the straight edge 46 (e.g., “about” meaning +/- 5 degrees). A user can then scribe the workpiece W (e.g., the underside of the workpiece W closest to the rear housing 18; the side facing away as viewed in FIG. 4) along the ruler 50. Alternatively, as illustrated in FIG. 4, the workpiece W may be located between the hinge portions 26 to square the workpiece W relative to the straight edge 46. As illustrated in FIG. 4, a dimension D along the length of the case 10 between the feet 54 and between adjacent hinge portions 26 corresponds to the width of the workpiece W. Accordingly, the angled projection 62 may be considered an auxiliary structure which performs an auxiliary function (e.g., at least contacting a workpiece W at a common angle relative to the straight edge 46) other than defining a storage space between the front housing 14 and the rear housing 18.

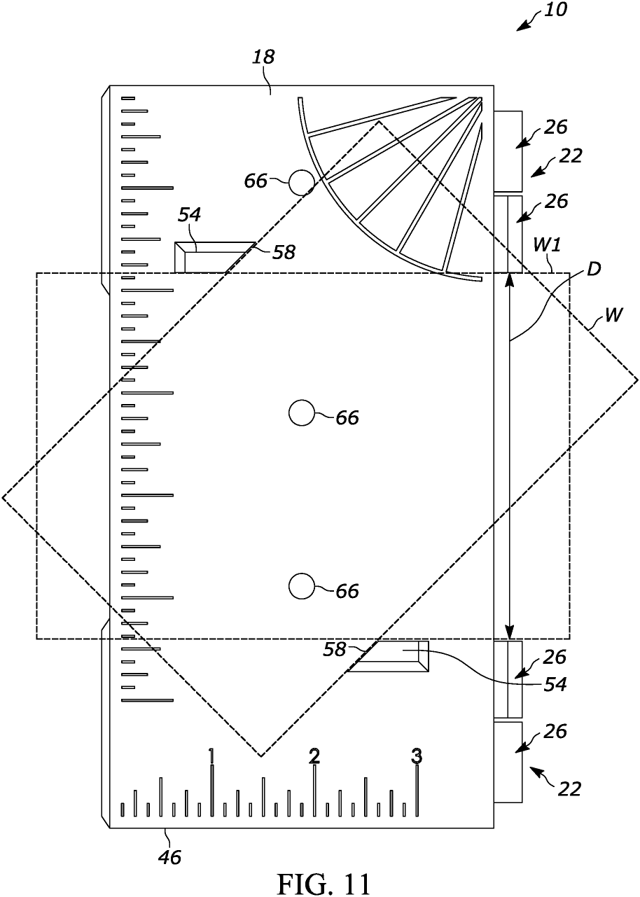

In another exemplary embodiment shown in FIG. 11, the rear housing 18 may include feet 54 that have extended angled surfaces 58. In this example, the rear housing 18 may be devoid of or provided without the angled projections 62. The feet 54 in the embodiment of FIG. 11 are further provided with straight edges 58a such that the workpiece W may be positioned in a first preset angle or a second preset angle that is different from the first preset angle. In the illustrated embodiment, the first preset angle defines a 45-degree angle relative to the straight edge 46 (as illustrated by the workpiece W), and the second preset angle defines a 90-degree angle relative to the straight edge 46 (as illustrated by the workpiece W1). In other embodiments, the first preset angle and/or the second preset angle may differ from the above-described exemplary preset angles. For example, the first preset angle and the second preset angle may be any desired angle between 0-degrees and 90-degrees (including but without limitation 0, 15, 30, 45, 60, 75, and 90 degrees). In other embodiments, the feet 54 may provide other preset angles between 90-degrees and 180-degrees relative to the straight edge 46 (including but without limitation 90, 105, 120, 135, 150, 165, and 180 degrees). In the 90-degree angle position (e.g., corresponding to a desired preset angle), the workpiece W1 rests on the straight edges 58a and the user may scribe the workpiece W1 (e.g., the underside of the workpiece W1 closest to the rear housing 18) along the ruler 50. The angled surfaces 58 and/or the straight edges 58a may be otherwise dimensioned to correspond with other common angles (e.g., 15, 22.5, 30, 45, 60, 75, 90 degrees) relative to the straight edge 46.

As shown in FIG. 2, the structure may include a recess 66 provided on the rear housing 18. The recess 66 may be provided at a particular location such that a kick stand 70 may engage the recess 66 to support the case 10 upon a surface S (See FIG. 16). The recess 66 is positioned on the rear housing 18 in a location which corresponds with the length of the kick stand 70 to support the case 10 at an angle A1 relative to the surface S. In some embodiments, the angle A1 may be a common angle such as 30, 45, or 60 degrees. The recesses 66 may be otherwise located in the rear housing 18 or the front housing 14 to support the case 10 at other angles A1. The kick stand 70 may be a drill bit or another rod-like structure having, for example, a circular or hexagonal cross-section. Accordingly, the recesses 66 may be considered an auxiliary structure which performs an auxiliary function (e.g., engaging a kick stand 70 to support the case 10 upon a surface S) other than defining a storage space between the front housing 14 and the rear housing 18.

As shown in FIG. 2, the structure may include an angle guide 74 provided on the rear housing 18. The angle guide 74 may be molded into the exterior of the rear housing 18. The angle guide 74 may function as a protractor, and may extend, as illustrated, along a 90-degree corner between adjacent straight edges 46 of the rear housing 18. Common angles such as 15, 30, 45, 60, and 75 degrees may be embossed by the angle guide 74 onto the exterior of the rear housing 18. Accordingly, the angle guide 74 may be considered an auxiliary structure which performs an auxiliary function (e.g., function as a protractor for illustrating at least one common angle) other than defining a storage space between the front housing 14 and the rear housing 18.

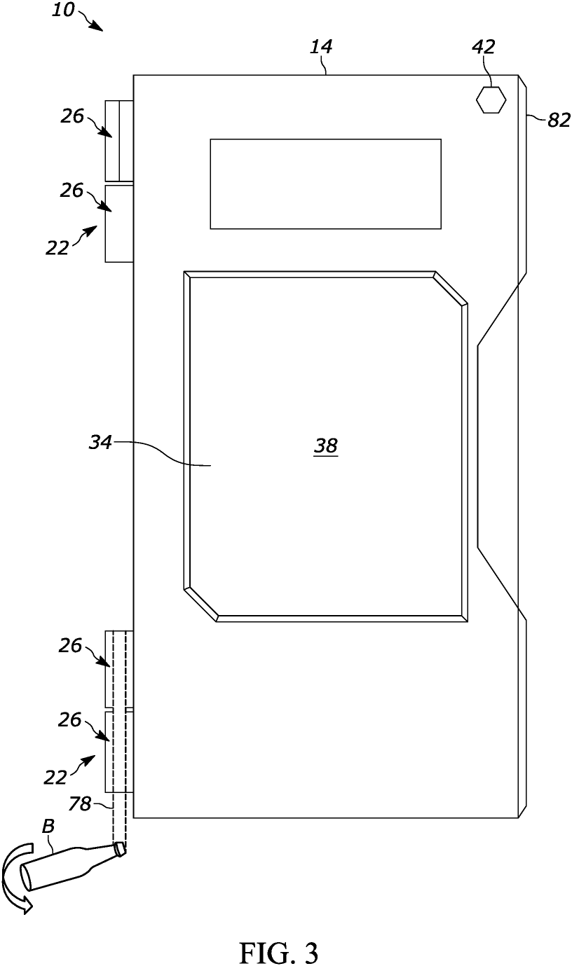

As shown in FIG. 3, the structure may include a bottle opener 78. In the illustrated embodiment, the bottle opener 78 may be secured to at least one of the hinge portions 26, although other locations of the bottle opener 78 are contemplated. A bottle B may engage the bottle opener 78, and the bottle B may be rotated such that a cap (not shown) of the bottle B is removed from the bottle B. Accordingly, the bottle opener 78 may be considered an auxiliary structure which performs an auxiliary function (e.g., engaging a cap of a bottle B to remove the cap from the bottle) other than defining a storage space between the front housing 14 and the rear housing 18.

As illustrated in FIGS. 3-4 and 6-8, the case 10 may further include a tab 82 secured to either the front housing 14 or the rear housing 18. The tab 82 projects beyond the front housing 14 and the rear housing 18 to provide a feature for a user to grasp to open and close the front housing 14 and the rear housing 18.

As illustrated in FIGS. 9 and 10, the front housing 14 and the rear housing 18 may each include a divider wall 86 therein to separate the storage space 30 from at least one auxiliary storage space 90. The auxiliary storage space 90 may further include a shank holder or receiver 94. As shown, the shank receiver 94 is dimensioned as a hexagonal shank receiver 94, although it will be appreciated that other shapes may define the shank receiver 94 (e.g., triangular, rectangular, heptagonal, octagonal, circular, non-polygonal, at least partially rounded, etc.). The shank receiver 94 is configured (e.g., by a press fit) to receive a shank of a fastener, bit, or other accessory therein to secure the fastener, bit or other accessory within the auxiliary storage space 90. In some embodiments, the shank, fastener, bit, or other accessory may be the same cross-sectional shape as the shank receiver 94 (e.g., a hexagonal shank receiver 94 and a hexagonal shank). In other embodiments, the shank, fastener, bit, or other accessory may differ in cross-sectional shape when compared to the shank receiver (e.g., a square shank receiver 94 and a hexagonal shank). In the illustrated embodiments of FIGS. 9 and 10, the front housing 14 and the rear housing 18 each define an auxiliary storage space 90 including at least one shank receiver 94. The front housing 14 may have the auxiliary storage space 90 adjacent the top of the front housing 14 and provided with the shank receiver 94. The rear housing 18 may have the auxiliary storage space 90 adjacent the bottom of the rear housing 18 and provided with the shank receiver 94. As such, the fastener, bit, or other accessory may be secured with the shank engaging the shank receiver 94 of one of the front housing 14 and the rear housing 18, and the remainder of the fastener, bit or other accessory may extend into the auxiliary storage space 90 of the other of the front housing 14 and the rear housing 18. Accordingly, the auxiliary storage space 90 and the shank receiver 94 may each be considered an auxiliary structure disposed within at least one of the front housing 14 and the rear housing 18 which performs an auxiliary function (e.g., facilitates storage) within front housing 14 and the rear housing 18.

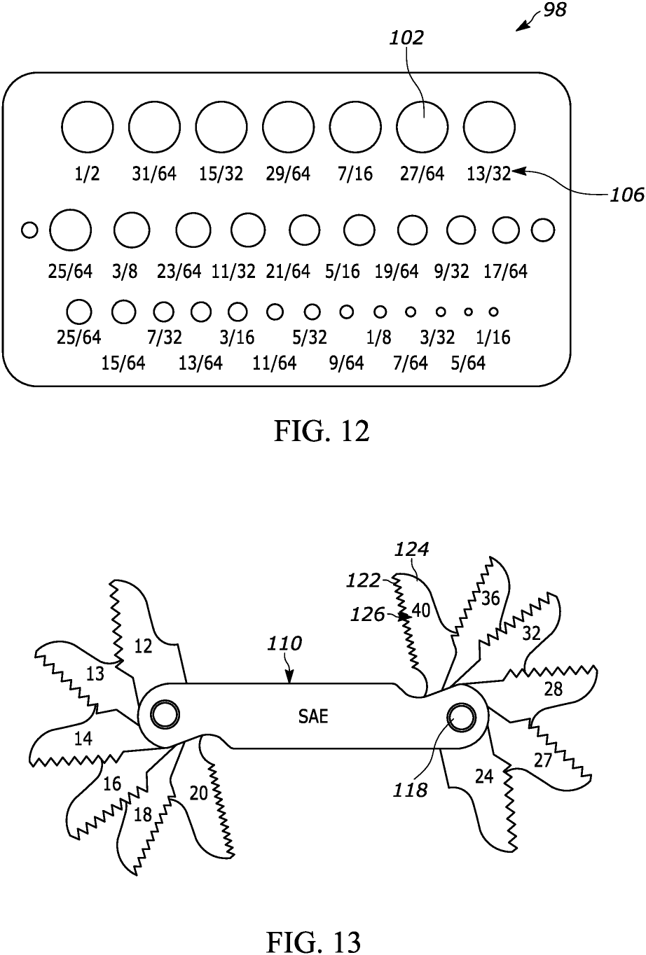

The case 10 as illustrated in FIGS. 1-11 may be provided with a drill bit reference guide 98 as illustrated in FIG. 12. The drill bit reference guide 98 is provided with holes 102 and indicia 106 adjacent each hole 102. The holes 102 are sized to receive a drill bit therein of a corresponding size. The indicia 106 are positioned adjacent (e.g., below) each hole 102 such that a user can easily determine what size drill bit is received in the hole 102. Accordingly, the drill bit reference guide 98 may be considered an auxiliary structure which performs an auxiliary function (e.g., identifying to a user the size of a drill bit) other than defining a storage space between the front housing 14 and the rear housing 18. The drill bit reference guide 98 may be positioned on an external surface of either or both of the front housing 14 and the rear housing 18. In other embodiments, the drill bit reference guide 98 may be positioned on an internal surface of either or both of the front housing 14 and the rear housing 18. In yet other embodiments, the drill bit reference guide 98 may be selectively attached to a stability structure (not shown) dimensioned to receive the drill bit reference guide 98 the within the internal storage space 30 to a position exterior to the internal storage space 30. In some embodiments, the drill bit reference guide 98 may be tethered to the case 10.

The case 10 as illustrated in FIGS. 1-11 may be provided with a screw pitch measuring device 110 as illustrated in FIG. 13. The screw pitch measuring device 110 includes a plurality of blades 114 secured to a pivot mechanism 118. The blades 114 are pivotable about the pivot mechanism 118 to expose teeth 122 of each blade 114. Each blade 114 is provided with a different number of teeth 122. Each blade 114 include an indicia 126 indicating the number of teeth 122 on the blade 114. The blades 114 can be positioned adjacent a fastener (not shown) to determine the pitch of the fastener. The number of teeth 122 that abut the fastener correspond to a pitch of the fastener. Accordingly, the screw pitch measuring device 110 may be considered an auxiliary structure which performs an auxiliary function (e.g., identifying to a user the pitch of a screw) other than defining a storage space between the front housing 14 and the rear housing 18. The screw pitch measuring device 110 may be positioned on an external surface of either or both of the front housing 14 and the rear housing 18. In other embodiments, the screw pitch measuring device 110 may be positioned on an internal surface of either or both of the front housing 14 and the rear housing 18. In yet other embodiments, the screw pitch measuring device 110 may be selectively attached to a stability structure (not shown) dimensioned to receive the screw pitch measuring device 110 within the internal storage space 30 to a position exterior to the internal storage space 30. In some embodiments, the screw pitch measuring device 110 may be tethered to the case 10.

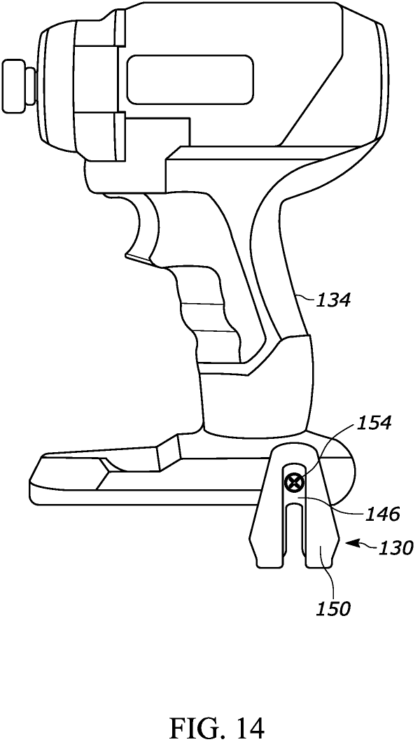

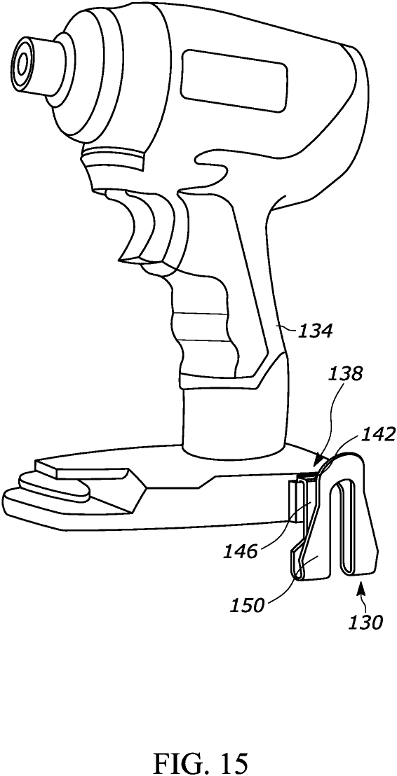

The case 10 as illustrated in FIGS. 1-11 may be provided with a belt clip 130 as illustrated in FIGS. 14-15. The belt clip 130 may be configured to engage a power tool 134. The power tool 134 includes a receptacle 138 through which an arm portion 142 of the belt clip 130 extends through. The belt clip 130 may be a U-shaped belt clip 130 having a first leg 146 and an opposite second leg 150. The arm portion 142 engages the first leg 146. Once received within the receptacle 138, a fastener 154 secures the belt clip 130 to the power tool 134. The case 10 may include a similar receptacle 138 through which the arm portion 142 may extend, and the fastener 154 may be used to secure the belt clip 130 to the case 10. Accordingly, the belt clip 130 may be considered an auxiliary structure which performs an auxiliary function (e.g., engaging both the case 10 and the power tool 134 or another object) other than defining a storage space between the front housing 14 and the rear housing 18.

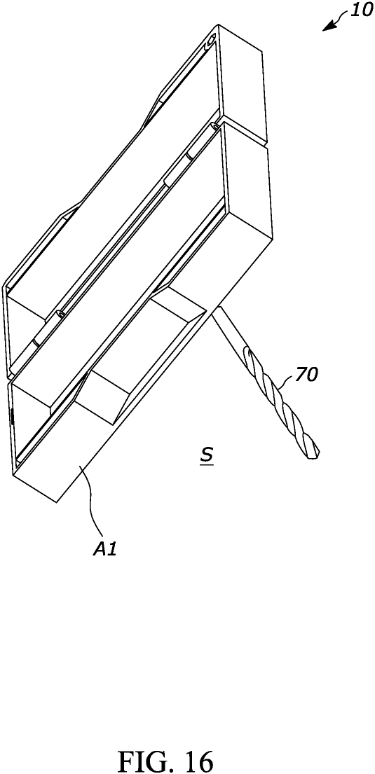

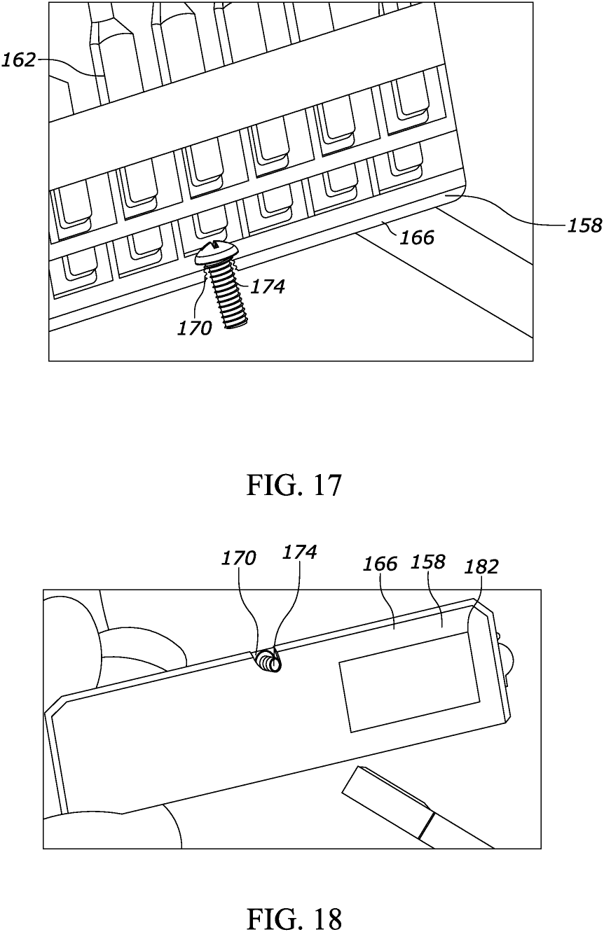

The case 10 as illustrated in FIGS. 1-11 may be provided with a bit bar 158 as illustrated in FIGS. 17-18. The bit bar 158 is configured to receive and stabilize bits 162 therein (e.g., by a press-fit) for storage on the bit bar 158. The bit bar 158 includes a plate 166 on a bottom surface thereof. The bits 162 extend towards the plate 166 when received within the bit bar 158. The plate 166 includes a hole 170 through which a fastener 174 extends. The fastener 174 may secure the bit bar 158 to the case 10. The bit bar 158 may otherwise be secured to the case 10. For example, the plate 166 may extend along the dimension D such that the bit bar 158 may be secured between adjacent hinge portions 26 of the case 10. Additionally or alternatively, (FIG. 18) the bit bar 158 may include a magnet 182. The magnet 182 may be located on the plate 166, and may be operable to secure the bit bar 158 to a metallic object. In some embodiments, the magnet 182 may secure the bit bar 158 to a magnetic portion of the case 10. In some embodiments, at least a portion of either the front housing 14 or the rear housing 18 is transparent to permit a user outside of the case 10 to view the bits 162 within the bit bar 158 through the transparent portion of either the front housing 14 or the rear housing 18. Accordingly, the bit bar 158 may be considered an auxiliary structure disposed within at least one of the front housing 14 and the rear housing 18 which performs an auxiliary function (e.g., facilitates storage of a bit) within front housing 14 and the rear housing 18. The bit bar 158 itself may also be removed from the interior of the case 10 and be considered an auxiliary structure which performs an auxiliary function (e.g., a magnetic support and a bit) other than defining a storage space between the front housing 14 and the rear housing 18.

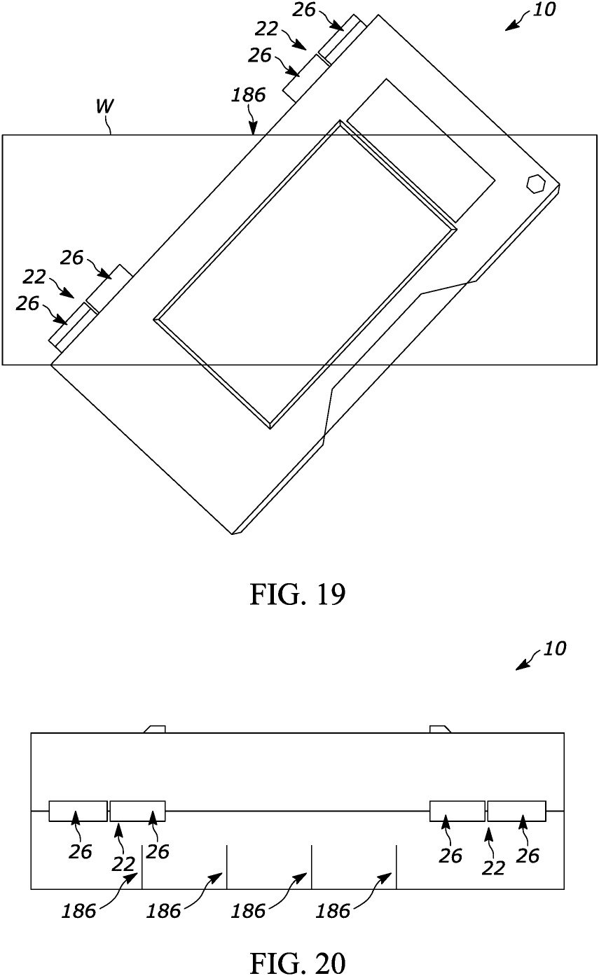

As illustrated in FIGS. 19 and 20, the case 10 may include indicia or angle indicators 186 on a side of either or both of the front housing 14 or the rear housing 18. The angle indicators 186 may align with a workpiece W so that when the angle indicators 186 are lined up with a surface of the workpiece W, the angle indicators 186 can indicate to the user an angle (e.g., 15, 30, 45, 60, 75, 90, etc. degrees) of the case 10 relative to the workpiece W. Accordingly, the angle indicators 186 may be considered an auxiliary structure which performs an auxiliary function (e.g., indicate to the user an angle of the workpiece W relative to the case 10) other than defining a storage space between the front housing 14 and the rear housing 18.

As shown in FIGS. 1 and 2, one or more auxiliary structures may be provided on either or both of the front housing 14 or the rear housing 18 of the same case 10. The one or more auxiliary structures may be disposed on the exterior of or within the interior of the front housing 14 or the rear housing 18, or both the front housing 14 and the rear housing 18. For example, with regard to FIG. 1, the front housing 14 includes the hex insert 42 and the recessed tray 34. With regard to FIG. 2, the rear housing 18 includes the ruler 50, feet 54, angled projections 62, recesses 66, and the angle guide 74. The same case 10 may include auxiliary structures that are illustrated in different figures. For example, the same case 10 may include feet 54, above-described divider wall 86, ruler 50, a hex insert 42, etc. Depending on desired configurations, the case 10 may be configured with any number and combination of the aforementioned auxiliary structures.

As illustrated in FIG. 21, the system 200 may include a first case 10 stacked on a second case 10. One or more projections or feet 54 extending beyond the rear housing 18 and away from the front housing 14 of one case 10 may be received in the recessed tray 34 of the second case 10. In the system 200, two or more cases 10 may be stacked in a similar manner onto one another. Each case 10 of the system 200 may include at least one auxiliary structure (e.g., measurement, stability, alignment of workpiece), a combination including multiple auxiliary structures, or all of the auxiliary structures described above with regard to the case 10.

Although aspects of the disclosure have been described in detail with reference to certain preferred embodiments, variations and modifications exist within the scope and spirit of one or more independent aspects as described.

What is claimed is:

1. A case comprising:
a first housing portion;
a second housing portion movably coupled to the first housing portion and cooperating with the first housing portion to define a storage space; and
a first auxiliary structure disposed on one of the first housing portion and the second housing portion and a second auxiliary structure disposed on one of the first housing portion and the second housing portion, wherein:
the first auxiliary structure includes a foot disposed on and extending from an exterior surface of the first housing portion, the foot configured to abut a workpiece to orient the workpiece in at least one preset angle relative to the first housing portion, and
the second auxiliary structure includes a recess.

2. The case of claim 1, wherein the at least one preset angle is between 45 degrees and 90 degrees.

3. The case of claim 1, further comprising an angled projection disposed on and extending from the exterior surface of the first housing portion, wherein the angled projection defines a part of the first auxiliary structure or defines a third auxiliary structure, and wherein the angled projection is configured to abut the workpiece to orient the workpiece in the at least one preset angle relative to the first housing portion.

4. The case of claim 1, further comprising a ruler provided on the exterior of the case.

5. The case of claim 1, further comprising a drill bit reference guide.

6. The case of claim 1, further comprising a screw pitch measuring device.

7. The case of claim 1, wherein the recess defines a recessed tray that is configured to define a second storage space.

8. The case of claim 7, wherein a portion of the recessed tray is magnetic.

9. The case of claim 1, wherein the recess is a hex insert.

10. The case of claim 1, wherein the recess is configured to receive a kick stand.

11. The case of claim 1, further comprising a bottle opener secured to a hinge of the case.

12. The case of claim 1, further comprising a belt clip provided on an exterior surface of the case.

13. The case of claim 1, further comprising an angle guide disposed on the case.

14. A system comprising:
a first case, comprising:
a first housing portion;
a second housing portion coupled to the first housing portion and cooperating with the first housing portion to define a first storage space;
a first hinge coupling the first housing portion to the second housing portion; and
a first auxiliary structure disposed on and extending from a first exterior surface of the first case, wherein the first auxiliary structure is configured to abut a workpiece to orient the workpiece in at least one preset angle relative to the first case, and
a second case, comprising:
a third housing portion;
a fourth housing portion coupled to the third housing portion and cooperating with the third housing portion to define a second storage space;
a second hinge coupling the third housing portion to the fourth housing portion; and
a second auxiliary structure disposed on a second exterior surface of the second case, wherein the second auxiliary structure is a recess, and
wherein the first auxiliary structure is configured to align with a portion of the second auxiliary structure to facilitate stacking of the first case over the second case.

15. The system of claim 14, wherein the recess is a recessed tray.

16. The system of claim 15, wherein a portion of the recessed tray is magnetic.

17. The system of claim 14, further comprising an angled projection disposed on and extending from the first case, wherein the angled projection defines a part of the first auxiliary structure and is configured to abut the workpiece to orient the workpiece in the at least one preset angle relative to the first housing portion.

18. The system of claim 14, wherein the preset angle is between 45 degrees and 90 degrees.

19. The system of claim 14, further comprising a ruler formed on one or more of the first housing portion, the second housing portion, the third housing portion, and the fourth housing portion.

20. The system of claim 14, further comprising a hex insert.
